(19) United States
(12) Patent Application Publication
(10) Pub. No.: US 2019/0373137 A1
(43) Pub. Date: Dec. 5, 2019

(54) BLOCKCHANNEL SCANNER SYSTEMS AND METHODS

(71) Applicants: RICHARD H. KRUKAR, Albuquerque, NM (US); LUIS M. ORTIZ, Albuquerque, NM (US)

(72) Inventors: RICHARD H. KRUKAR, Albuquerque, NM (US); LUIS M. ORTIZ, Albuquerque, NM (US)

(21) Appl. No.: 16/429,065

(22) Filed: Jun. 3, 2019

Related U.S. Application Data
(60) Provisional application No. 62/679,933, filed on Jun. 3, 2018.

(51) Int. Cl. H04N 1/44; G06F 3/12; G06F 21/60; H04L 9/06; H04L 9/08; H04L 9/14

(52) U.S. Cl. CPC H04N 1/4486; H04N 1/444; H04N 1/4413; G06F 3/1222; H04L 2209/38; G06F 21/602; H04L 9/0637; H04L 9/0825; H04L 9/14; G06F 3/1238

(57) ABSTRACT

Blockchannel systems use encryption and block chains to create channels between sensors and monitors such as data rendering devices. For example, a document scanner (sensor) creates encrypted documents by scanning items, encrypting the scans, and publishing using a blockchain. A second device, such as a printer, actively monitors the blockchain looking for documents it can decrypt, decrypts them, and prints them. This technique negates much of the present day access coordination because the printer doesn't require a print server or print queue. A publicly accessible blockchain can be print server and print queue for every printer without requiring trust between printers, scanners, or other devices having access to the blockchain. The sensor can be a document scanner, sensor, video recorder, environmental sensor, intrusion detector, etc. The monitor can be a data rending device (printer, electronic display), data analysis equipment, fire alarm, intrusion alarm, alarm monitor, data fusion system, Al, etc.

### INVENTION PRIORITY

The present invention claims priority as a to provisional patent application Ser. No. 62/679,933, which was filed Jun. 3, 2018, entitled “Blockchannel Scanner Systems and Methods”, and is herein incorporated by reference in its entirety for its teachings.

### FIELD OF THE INVENTION

The embodiments are related to the secure management of documents over networks. More particularly, the present embodiments are related to use of blockchain-related technology to manage the distribution, access and rendering of documents. The present embodiments are also related to utilization of scanners and data rendering devices that leverage blockchain technology to manage public access to documents and rendering of data contained in documents, essentially enabling a channel (a “blockchannel) to and from the blockchain to access documents/data for its intended use.

### BACKGROUND

Blockchain technology surfaced in 2008 for use in the cryptocurrency bitcoin as its public transaction ledger. The use of the blockchain for bitcoin made it the first digital currency to solve the double-spending problem without the need of a trusted authority or central server. Bitcoin's blockchain has inspired other applications. Those applications typically expand on and incorporate aspects of bitcoin's design.

A blockchain is a continuously growing list of records, called blocks, which are linked and secured using cryptography. Each block typically contains a cryptographic hash of the previous block, a timestamp and transaction data. By design, a blockchain is inherently resistant to modification of the data. Blockchains are often describes as open, distributed ledgers recording transactions in a verifiable and permanent way. This description is true for many blockchains although private blockchains and hybrid public/private block chains have been deployed. For use as a distributed ledger, a blockchain is typically managed by a peer-to-peer network collectively adhering to a protocol for inter-node communication and validating new blocks. Once recorded, the data in any given block cannot be altered retroactively without the alteration of all subsequent blocks, which requires collusion of the network majority.

Blockchains are secure by design and exemplify a distributed computing system with high Byzantine fault tolerance. Decentralized consensus has therefore been achieved with blockchains. This makes blockchain technologies useful for many applications including the recording of events, medical records, and other records management activities, such as identity management, transaction processing, documenting provenance, food traceability or voting. The different cryptographic techniques are important and should be understood to understand as background for the embodiments that follow.

Symmetric key encryption refers to techniques using the same key for both encryption and decryption. Data is encrypted with the key to produce encrypted data. Encrypted data is decrypted with the key to recover the data. This technique is useful for keeping data secret until the key is revealed. Anyone with the key can encrypt data. Anyone with the key can decrypt the encrypted data. This technique provides data secrecy because only those knowing the key can access the data. This technique does not provide authentication because everyone with the key can produce encrypted data. Aspects of symmetric key cryptography are described in U.S. Pat. No. 5,214,703, filed Jan. 7, 1992, and titled “Device for the conversion of a digital block and use of same” which is incorporated herein by reference in its entirety.

Public key cryptography, a.k.a. “asymmetric key”, refers to techniques using two keys, called a key pair. Typically, one of those keys is called the public key and the other is called the private key. When a key pair is produced, the user can keep one key private (the private key) and can give out the other key (the public key). Data encrypted with the private key can only be decrypted with the public key. The opposite is also true—data encrypted with the public key can only be decrypted with the private key. Applying this—a person can publish authenticated messages because the recipients know the source of the messages. Similarly, anyone can send a private message to the person. Aspects of public key cryptography are described in U.S. Pat. No. 4,405,829, filed Dec. 14, 1977, and titled “Cryptographic communications system and method” which is incorporated herein by reference in its entirety.

To send an authenticated message, the person first shares the public key in such a manner that the recipients know that they have the person's public key. The person can then encrypt messages with the private key, thereby authenticating them. Everyone with the public key can read the messages and can be sure the messages came from the person, unless the private key has been compromised. This use of public key cryptography provides authentication but not secrecy because everyone with the public key can read the message but only the one person could have produced the message.

To send a private message to the person, someone with public key used the public key to encrypt the private message. The only one who can decrypt the private message is the person having the private key. This use of public key cryptography provides secrecy but not authentication because everyone with the public key can produce the private message but only the one person can decrypt the message.

People can communicate securely by first—securely-sharing their public keys, perhaps by making their public keys known to everyone in a verifiable manner. A first person can encrypt a message with their own private key and then with the second person's public key. The second person can decrypt the message with their own private key and then with the first person's public key. In this manner, the second person knows the first person sent the message and that only the second person can fully decrypt the message. This use of public key cryptography provides secrecy and authentication because only the first person could have produced the message and only the second person can decrypt the message.

The previous description used the word “authentication” to mean that the source of the message/data is known. (Note: the words “message” and “data” are being used interchangeably.) Authenticated messages are sometimes referred to as “signed” messages, particularly when a digital signature algorithm is used to sign data with a digital signature.

Specific algorithms, such as the Digital Signature Algorithm (DSA) and the Elliptic Curve Digital Signature Algorithm (ECDSA), produce digital signatures of data. DSA has been adopted by the NIST for use in their Digital Signature Standard (DSS). ECDSA is used within popular public blockchains such as those of bitcoin and ethereum. Aspects of DSA are described by U.S. Pat. No. 5,231,668, filed Jul. 26, 1991 and titled “Digital Signature Algorithm.” Aspects of ECDSA are described by U.S. Pat. No. 6,212,279, filed Jul. 23, 1998 and titled “Method of elliptic curve cryptographic key exchange using reduced base tau expansion in non-adjacent form” and by U.S. Pat. No. 6,243467, filed Jul. 23, 1998 and titled “Method of elliptic curve cryptographic digital signature generation and verification using reduced base tau expansion in non-adjacent form.” The terms “private key” and “public key” as commonly used in relation to digital signatures are different from those same terms as commonly used in relation to public key encryption systems. To avoid ambiguity, a “signing key” is a digital signature algorithm's “private key” while a “confirmation key” is a digital signature algorithm's “public key.” For their descriptions of digital signatures and the use of digital signatures, U.S. Pat. No. 6,212,279, 6,243467, and 5,231,668 are incorporated herein by reference in their entirety.

Digital signatures are used to sign data as follows. The user creates a signing key, creates a confirmation key from the signing key, and shares the confirmation key. The user signs the data by using the signing key to produce a digital signature of the data. Anyone receiving the data and the digital signature can use the confirmation key to confirm the digital signature. More specifically, the signing operation can take the data and the signing key as inputs and produces a digital signature. The confirmation operation can take the data, the digital signature, and the confirmation key as inputs and produces an output either confirming or rejecting the digital signature. Different data has a different digital signature even when signed by the same signing key. These techniques provide data authentication but no data secrecy because these signing operations do not encrypt the data. As such, the data is easy to read and those interested can test the signature.

Merkle trees, also called hash trees, are a core technology for many distributed data store implementations and distributed hash table implementations. Merkle trees are described in U.S. Pat. No. 4,309,569 that issued on Jan. 5, 1982 and is titled “Method of Providing Digital Signatures”. U.S. Pat. No. 4,309,569 is included herein by reference in its entirety. Using Merkle trees, cryptographically signed pieces of a document (or data file or data blob) can be stored, perhaps redundantly stored, by the nodes of a computer network. The original document can be obtained by using its digital signature to find the root of the Merkle tree, then traversing the Merkle tree until all the pieces have been obtained. The document can be encrypted before being split into pieces.

Those interested in cryptography and blockchain implementations are familiar with symmetric key cryptography, public key cryptography, digital signatures, and Merkle trees.

Blockchains use digital signature algorithms such as ECDSA. As with other digital signature algorithms, a person creates an ECDSA signing key and uses it to create a ECDSA confirmation key. The confirmation key can be used as an address on the blockchain. After being generated, the confirmation key is typically formatted, sometimes with additional data, into a character sequence, image, or some other form that makes it easy for humans to share. Cryptocurrency enthusiasts often refer to these character sequences as an addresses, e.g. a bitcoin address or ethereum address. A blockchain implementation or design typically specifies of the data, including a confirmation key, encoded in the character sequences/images/etc. A transaction can be entered onto the block chain by associating it with a confirmation key or address, and signing the transaction with the signing key. As such, only someone having the signing key can record a signed transaction for a particular address, but anyone can verify the transaction because the confirmation key is readily available. For example, the transaction “send 1 bitcoin from address A to address B” is signed with the signing key for address A. All the transaction details are publicly readable, including the addresses and digital signature. The digital signature is used to ensure that only the “owner” of address A can send bitcoin from address A. The seminal bitcoin “white paper” by Satoshi Nakamoto, disclosing the first blockchain based cryptocurrency, is attached hereto and is incorporated by reference in its entirety.

In general, a blockchain is a ledger of transactions. Some transactions transfer value from one blockchain address to another, others simply record information at a blockchain address. A “world state” or blockchain state is the status of all those blockchain addresses at a particular time. In practice, numerous interested entities maintain databases storing certain blockchains' world state in an easily searched manner. The world states are maintained and updated as transactions are recorded on the blockchain. Easily searchable world states are needed because a person wanting to know the number of tokens stored at a blockchain address wants the answer in a reasonable time. If the world state is not available then every transaction on the blockchain has to be examined to determine the current number of tokens at an address. It is up to the person querying the database to decide if she trusts what is stored in a world state database. The blockchain itself, however, is trusted.

A document scanner can be viewed as a sensor. Scanners include page document scanners familiar in multifunction machines, optical scanners, cameras (e.g., still and video), and special purpose scanners (e.g., environmental scanners). Data rendering devices can include various hardware and services. For example, a document printer, video monitor, projector, display screen, computer, mobile device, etc., can be considered a data rendering device.

What are needed are systems and methods for the management of documents over networks. It is an objective of the present inventors to teach the use of blockchain-related technology to manage the distribution, access and rendering of documents. What is also needed are enhanced means to utilize sensors (e.g., scanners) as producers of data included in documents and data rendering devices as producers of documents based on data where public access is involved or desired.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

A core concept of this disclosure is that data can be channeled from one entity to a second entity using encryption and without requiring user accounts having logins and similar access credentials. Either the second entity can decrypt the data or it can't. This idea came during the contemplation of a secure access dialog while submitting a print job to a printer and realizing that there is an easier way.

A print job for a document authored at a computer can be encrypted with an encryption key. Using asymmetric encryption, the user has a private key and the printer stores a plethora of public keys, each public key associated with account data for a particular user. When the printer receives a print job, it tries to decrypt it with every key it knows. If one of the public keys decrypts the print job then the printer automatically knows which user submitted the print job (the user associated with the public key that worked). There is no login required. The same utility can be obtained using digital signatures—every stored verification key is checked and successful verification identifies the user who signed the print job. Similarly, symmetric key encryption works but with the risk that anyone with access to the printer's key storage can steal users' identities.

A further observation is that print queues can be globalized. Every print job can be submitted to a massive and publicly accessible data store (being grandiose here, could be something more humble like a local server). A printer having access to the data store can examine every job to determine which print jobs it can print. The printer can print any job the printer can decrypt using any of the stored keys. Users wanting privacy might avoid digital signature embodiments allowing the document to be read by any entity with access to the data store. For efficiency, each printer can attempt decrypting a header element or other discrete portion of each print job before downloading only those print jobs the printer can decrypt. As before, successful decryption also means knowing which user submitted the print job.

A document can be “faxed” by scanning it, encrypting it, and tossing it into the global data store. The document can then be automatically printed out by a printer having the correct decryption key, essentially creating a channel with the end points specified by a key pair. In addition, any data source, such as a sensor, can publish encrypted data into the global data store and any entity with the proper decryption key can read the data. For example, the sensor can be a light switch whose data is read of the global data store by some light bulbs, a phone app showing what lights are on, and an Al (artificial intelligence) analyzing patterns of switch activations. The entities reading the data need the correct decryption key, nothing more.

With sensors, time stamps can clarify when a switch was flipped. With print jobs and other tasks, there is a danger of the same task being performed repeatedly. For example, a griefer having access to the global data store can make dozens of copies of a print job by simply copying them. This is similar to the double spending problem solved by cryptocurrencies. Hence the block channel. Each print job can be associated with an address on a blockchain (recalling that a block chain addresses can be, or contain, the verification key for a digital signature). The number of times a print job is printed can be controlled by associating the print job with a blockchain address and recording transactions at that address. For example, the print job can be paid for with a cryptocurrency or crypto-coin/token. A flag can be set at the blockchain address, a counter can be incremented, or other data stored there. The print job can be stored directly on a blockchain or can be stored elsewhere and referenced by the blockchain.

Printers can monitor blockchain transactions to find print jobs, essentially making the printer a proactive network entity looking for work. For example a transaction can indicate a print job has been created and give its location. The blockchain transaction can contain a discrete portion of the print job for immediate testing against the printer's stored keys. Note that encrypting a print job encrypts the documents within the print job, although some print job data could remain unencrypted.

The blockchain address associated with a print job does not have to also be associated with a blockchain transaction when the print job becomes globally available. For example, the print job can contain a signing key that is unique to the print job. The printer decrypting the print job also learns the signing key. The blockchain address can be contained in the print job or can be generated using the signing key. Upon printing the job, the printer can use the signing key to record a transaction on the blockchain indicating the job is done. That one single “job done” transaction could be the only transaction on the blockchain for that blockchain address because no transaction is entered until the task is complete. A variation of this method can have a printer recording a transaction claiming the job before expending resources performing the job. The “job done” or “job claimed” data can be cleared (likely requiring the signing key to sign the data clearing transaction) if another printed copy of the document is desired.

It is a feature of the disclosed embodiments to provide systems and methods for the management of documents over networks using blockchain-related technology. The technology can be used to manage the acquisition, distribution, access and rendering of documents containing data.

It is another feature of the embodiments to provide enhanced means to utilize sensors (e.g., scanners) as producers of data included in documents and to utilize data analyzers and data rendering devices (e.g., printers, media displays) as renderers of documents, especially when the data store (blockchain, merkle tree, distributed file system, global data store, etc.) is public or widely accessible.

It is another feature of the embodiments to provide a blockchanneling system, essentially creating a channel between sensor and data rendering devices via the blockchain, for data registered/stored in a distributed ledger comprising the blockchain. The syem including a sensor adapted to scan and encrypt documents using a public key and to store the documents, or a reference to the documents, in a blockchain, and a data rendering device adapted to obtain data from the blockchain and to decrypt and render the data contained in the document. Encryption applied to scanned documents can include asymmetric key encryption or symmetric key encryption. The sensor can be a document scanner, and the data rending device can be a document printer.

In accordance with another feature of the embodiments, a method for managing documents in a publicly available distributed ledger system (e.g. blockchain) using asymmetric cryptography is described. A document can be scanned and encrypted with a public key at any sensor using a public key provided to the sensor. The key can be provided by a user or by a device associated with the user (smart phone) that keeps track of encryption keys. A new and unique distributed ledger address can be created for the document. The document can be accessed from the distributed ledger. The document can be rendered at a data rendering device using a private key.

In accordance with features of the embodiments, a user can submit a data rendering job, e.g., print job, to a service linked to, for example, a printer, the service can return a cost and a blockchain address. A user can then transfer the cost to one of the service's block chain addresses and then the document is printed. Three different people can be involved: the one who scans; the one getting the printed document; and the one who pays. The one who scans only needs the public key. The one getting the printed document only needs the private key. The one paying only needs the block chain address. The various people involved are likely to use phone apps such that keys and blockchain addresses do not have to be entered character by character. Those familiar with cryptocurrency apps and hardware (e.g. the ledger nano storing keys in a device similar in form factor to a USB flash drive; the apps and web sites for cryptocurrency exchanges like Kracken, Binnance, and CoinBase) are familiar with hardware and software based key storage systems. Alternatively, scannable codes such as QR codes can carry the keys in a convenient manner. Those familiar with paper wallets (often used for bitcoin and ethereum) are familiar with scannable codes such as QR codes.

In accordance with other features of the embodiments, a user can submit a print job to a service, the service returns a cost, x tokens. A printer can have block chain addresses that it can communicate to users via NFC, RFID, QR code, web address, etc. The user can have a block chain address holding “print” tokens or cryptocurrency. The user's blockchain address and the document (encrypted or not encrypted) can be included as part of the print job. The user can submit the print job to the printer and also record an “approve” type transaction on the block chain approving transfer of x tokens from user's address to one of the printer's blockchain addresses. The printer can use a “transferFrom” type transaction to get the tokens and can then print the document. The printer can know whose job to print because it can observe, on the blockchain, that the source of the tokens is the user's blockchain address. If the printer provided a unique blockchain address to the user and the user also included that blockchain address in the print job, then the printer can know which of the user's print jobs to print based on the printer-provided block chain address and can use a “transferFrom( )” type transaction to secure payment even if the user has submitted multiple jobs using the same one of the user's blockchain addresses. The document's encryption does have to used to identify the user because the user's wallet address can be used to handle payment and perhaps to identify the user.

In accordance with additional features of the embodiments, a printer can have numerous blockchain addresses and can generate and provide a new one every time someone asks for one. A blockchain address can be specific to the printer. A block chain address can be specific to a group of printers spread over numerous locations with the printer actually performing the print job also recording the “transferFrom” or dialoging with a service that records the transferFrom. The service can be software running on one or more computers and that can record transactions on the block chain. The number of blockchain addresses is virtually limitless; as such any entity can have as many blockchain addresses as the desired, can generate them freely, can use them once and then forget them, and can store millions of addresses of interest.

In accordance with yet additional features of the embodiments, each data rendering job (e.g., print job) can have a unique blockchain address. For example, a print job, encrypted with the printer's public key, can include the signing key used for signing transactions on the print job's blockchain address. The printer receives the print job, decrypts it, and checks to see if the blockchain address holds enough currency/tokens to pay for the job. If the printing cost can be covered, the printer can use the signing key to generate a transaction deducting the printing cost from the blockchain address and can print the job (perhaps waiting for the transaction to be confirmed). The printer can monitor for more tokens being stored at the print job's unique block chain address and, whenever sufficient funds appear the printer can deduct the printing cost and print a copy—this can essentially create a print-on-demand function for a specific document at a specific printer because only a device having the proper decryption key can decrypt the print job and harvest tokens from the unique blockchain address. The printer prints another copy whenever sufficient payment appears.

In accordance with yet other features, confirmation can be provided over the process. A—document—can store information/rules about how the user (who stands to get billed) wants to confirm transactions. The printer (or other data rendering device) can have its own access controls/rules for confirming printing. The rules can include trusting submission from specific locations (IP address range, specific devices, specific scanner, digitally signed by specific entities, . . . ), requiring an NFC bump from the users device to the printer (or to a networked NFC bumper—a bump server?), proximity between user's device and printer (RFID, beacon, location services on phone, . . . ), clicking a link in a message or email, voice command/agreement through a device near the user. A user can confirm by making payment before printing or by recording a transaction on a blockchain. This requires encrypted documents to be packaged with information that can determine printing cost (page count, BW/color, binding, media weight, media color, media finish (gloss, mat, . . . ), etc.).

In yet additional features of the embodiments, data rendering can be limited to specific devices (e.g., securely limiting printing to specific printers) using double encryption. A printer's (or print group's) public key can be used to encrypt an envelope containing an already encrypted document (or envelope header, or the like). Here, the printer has its own private key(s) in addition to the keys entered by users. A candidate print job is a print job the printer can test against the printer's decryption keys. Upon discovering a candidate print job, the printer can attempt decryption using all the user keys the printer knows. If a key successfully decrypts the candidate print job, then the printer can proceed to print the print job. The printer can also attempt to decrypt the print job using its own private key(s). Successful decryption indicates that the print job is meant for the particular printer by some entity, perhaps an anonymous entity, knowing the printers public key, the printer can opt to print the job based on criteria such as payment received (perhaps via blockchain transaction) The double encryption aspect is that the printer can attempt decryption using two keys in sequence, one of the printers private keys and one of the users keys. Successful decryption reveals the specific user associated with the print job while also limiting the printing to a specific printer (or set of printers). In any case, successful decryption means the print job can be approved, payment can be requested, and account debited, a blockchain transaction recorded, etc.

A printing system can include a printer that can access a database of user data. The database of user data can associate users with decryption keys. For example, a “NoSQL” database can have key-value pairs that returns a value in response to a query on a key. “Key” used in the database sense does not necessarily equate with the cryptographic keys discussed here. However, a cryptographic key can certainly be used as a database key with the returned value being user information (e.g. a JSON object with user name, etc.). The printer can store known decryption keys inside or outside the database. Known decryption keys are those that the printer “knows” by storing them locally or remotely. For example, a printer can obtain known decryption keys by asking the database for a list of all the decryption keys stored in the database, then add those to its current locally stored known decryption keys (preferably pruning out repeats). A modest computer can store and use millions, perhaps billions, of decryption keys. Depending on decryption key length, the number of possible keys can outnumber the number of particles in the universe. As such, the number of stored decryption keys is infinitesimal compared to the number of possible decryption keys.

The printing system can receive an encrypted document from an unknown use and can try decrypting the document with each of the decryption keys (preferably stopping upon successful decryption). Upon successful decryption with one of the decryption keys, the printer can print the document if an entity associated with the correct decryption key is allowed to use the printer or to print the document. The decryption key that worked (the “correct decryption key”) may be stored in the database of user data and associated there with a known user. As such, the previously unknown user is identified based on the correct decryption key and becomes known. The known user can pay for the printing. For example, the user data can contain billing information for charging the user's credit card, debiting the users account, or adding a charge to an invoice.

User data can be recorded on a blockchain. In such an embodiment, the database of user data can be a database storing a blockchain state such as the “world state” of the blockchain. The ethereum yellow paper defines the world state as: “The world state (state), is a mapping between addresses (160-bit identifers) and account states.” Here, the account state is the user data because this particular blockchain maps between addresses and user data.

Some blockchains are used for recording crypto-currency transactions (e.g. bitcoin, ethereum). In such blockchains, the account state can be, or include, a blockchain value such as an amount of crypto-currency that can be used to pay for the completion of a task such as printing a document. If the blockchain value equals or exceeds the cost to print the document then the printer can subtract the printing cost from the blockchain value and print the document. Typically, a transaction is submitted and the printing is delayed until after the transaction is securely recorded on the blockchain. Some embodiments can repeatedly subtract the printing cost from the blockchain value, printing a copy of the document each time the printing is paid for via the blockchain. The printer can monitor the blockchain value, triggering another printing every time the blockchain value meets or exceeds the printing cost.

Cryptographic signature can be used to identify the person desiring completion of a task such as printing a document. A printer can receive a cryptographically signed document. The document can be signed using DSA, ECDSA, or another cryptographic signing algorithm where a signing key is used to produce the document's digital signature. Testing the digital signature with a confirmation key confirms that the entity that signed the document was in possession of the signing key. As with the known decryption keys discussed above, the printer can have a number of known confirmation keys. Each of the known confirmation keys can be tested to see which, if any, confirms the digital signature.

Upon successful confirmation with one of the confirmation keys, the printer can print the document if an entity associated with the correct confirmation key is allowed to use the printer or to print the document. The confirmation key that worked (the “correct confirmation key”) may be stored in a database of user data and associated there with a known user. As such, a previously unknown user is identified based on the correct confirmation key and becomes known. The known user can pay for the printing.

As discussed above, a blockchain can record user data. The user data can include entities' confirmation keys. A database of the world-state of this particular blockchain can use the confirmation key as the database key or can be indexed on the confirmation key (same as with the decryption key of the decryption key embodiments).

An entity can use the same confirmation key as an address for both the user data blockchain and a crypto-currency blockchain. In such a case, the account state of one blockchain can be user data and of the other can have a blockchain value. The two blockchains can be combined in some embodiments. To get paid for the printing, a printer can submit a transaction, such as a “transferFrom( )” transaction, to address on the crypto-currency blockchain. Here, “crypto-currency blockchain” indicates that a blockchain value, such as an account balance (number of tokens or amount of crypto-currency) is recorded on the blockchain (e.g. bitcoin, ethereum) at the address. The user data can include a credit card number such that a credit card can be charged for the printing. Given the visibility of blockchain transactions and account states, the credit card information should be encrypted to restrict readability to the printer, or a payment service used by the printer.

It is not strictly required that the user be identified by user data associated with the confirmation key. If the confirmation key is an address on a crypto-currency blockchain and the printer can be paid from the account balance mapped to the confirmation address, then the printer gets paid without knowing exactly who wanted the printed document. Here, the printer determines the correct confirmation key, obtains payment in crypto-currency, and prints the document. As such, some embodiments allow for anonymous users, others require that users be known. Credit/debit card transactions likely require that the user be known such that the proper information, including cost of printing, can be provided to a payment processor for the credit/debit card.

Documents and other data can be stored such that they can be retrieved in a content addressable manner such as in a swarm, torrent, etc. (e.g. bitTorrent, IPFS). A document's digital signature can be the address of the document and can be used to obtain the document. Once obtained, the printer can attempt to confirm the digital signature with the printer's known confirmation keys. A user database can associate confirmation keys with known users and can use the user database to determine if printing is allowed. Alternatively, the database can simply associate confirmation keys and an “allowed to print” flag. In another alternative, the confirmation key can be used, as discussed above, to obtain payment in crypto-currency. If print is allowed, the document is printed.

Existing systems and methods use content addressable data stores so that documents stored in the datastore are content addressable and can be retrieved in a content addressable manner. BitTorrent, amongst others, uses magnet links that include the addresses for content addressable retrieval. BitTorrent, the ethereum swarm, and IPFS all use peer-to-peer networks for data storage and that data is typically content addressable. The peer-to-peer networks comprise a number of cooperating nodes (networked computers) and can split data, such as a document, into separate pieces and store those pieces on different nodes in the peer-to-peer network. For example, Merkle trees can have the document pieces at the tree's leaf nodes (not necessarily the same as network nodes). And those leaf nodes can be distributed amongst the network nodes of a peer-to-peer network. The document can be assembled by pulling the pieces from the peer-to-peer nodes.

Document identifiers can be recorded in a blockchain and printers can monitor the transactions being recorded on the blockchain. As discussed above, a magnet link can be a document identifier as can the document's digital signature as can be a datum, data blob, or structured data that includes the document's digital signature. Upon noticing the document identifier, the printer can examine the document or a piece of the document to determine if the printer knows the correct decryption code or confirmation key. If so, the printer can determine if printing is allowed, can debit an account for the printing costs, can receive payment via a crypto-currency blockchain, etc.

The printer can keep track of which blocks it has already examined (old blocks), which documents it has already printed, and other data such that the printer does not print documents that no longer need printing. For example, the printer can record the number of the most recent block (blocks usually have a sequence number or block number). Blocks having a block number higher than the most recent block are new blocks while the rest are old blocks. Document identifiers in old blocks are old document identifiers. By ignoring old blocks, the printer does not obtain old document identifiers. If blocks can be examined out of order then the skipped blocks should be noted such that they aren't ignored.

### BRIEF DESCRIPTION OF THE DRAWINGS

The accompanying figures, in which like reference numerals refer to identical or functionally similar elements throughout the separate views and which are incorporated in and form a part of the specification, further illustrate the disclosed embodiments and, together with the detailed description of the invention, serve to explain the principles of the disclosed embodiments.

FIG. 1 illustrates a system diagram, in accordance with features of the embodiments.

FIG. 2 illustrates a flow diagram of a method, in accordance with features of the embodiments.

FIG. 3 illustrates a flow diagram of a process, in accordance with features of the embodiments.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth in this document; example embodiments are provided merely to be illustrative. Likewise, a reasonably broad scope for claimed or covered subject matter is intended. Among other things, for example, subject matter may be embodied as methods, devices, components, or systems. Accordingly, the non-abstract embodiments may, for example, take the form of hardware, software, firmware or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms, such as “and”, “or”, or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “scanning”, “processing”, “computing”, “calculating”, “determining”, “establishing”, “analyzing”, “checking”, “rendering”, “printing” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more.” For example, “a plurality of items” includes two or more items.

References to “one embodiment,” “an example embodiment,” “an embodiment,” “demonstrative embodiment,” “various embodiments,” “exemplary embodiment” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a Smartphone device, a smart watch, wearable computing devices, a server computer, a handheld computer, a handheld device, a Personal Digital Assistant (PDA) device, a handheld PDA device, an on-board device, an off-board device, a hybrid device, and RFID-enabled device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (NV) device, a wired or wireless network, a cellular network, a cellular node, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, printers, scanners, displays, projectors, and the like.

Note that the term “server” if utilized herein refers generally to a computer that provides data to other computers. Such a server can serve data to systems on, for example, a LAN (Local Area Network) or a wide area network (WAN) over the Internet. Many types of servers exist, including web servers, mail servers, and files servers. Each type can run software specific to the purpose of the server. For example, a Web server may run Apache HTTP Server or Microsoft IIS, which both provide access to websites over the Internet. A mail server may run a program such as, for example, Exim or iMail, which can provide SMTP services for sending and receiving email. A file server might utilize, for example, Samba or the operating system's built-in file sharing services to share files over a network. A server is thus a computer or device on a network that manages resources. Other examples of servers include print servers, database servers and so on. A server may be dedicated, meaning that it performs no other tasks besides their server tasks. On multiprocessing operating systems, however, a single computer can execute several programs at once. A server in this case may refer to the program that is managing resources rather than the entire computer.

Some embodiments may be used in conjunction with devices and/or networks operating in accordance with existing Long Term Evolution (LTE) specifications, e.g., “3GPP TS 36.304 3rd Generation Partnership Project; Technical Specification Group Radio Access Network; Evolved Universal Terrestrial Radio Access (E-UTRA); User Equipment (UE) procedures in idle mode”; “3GPP TS 36.331 3rd Generation Partnership Project; Technical Specification Group Radio Access Network; Evolved Universal Terrestrial Radio Access (E-UTRA); Radio Resource Control (RRC); Protocol specification”; “3GPP 24.312 3rd Generation Partnership Project; Technical Specification Group Core Network and Terminals; Access Network Discovery and Selection Function (ANDSF) Management Object (MO)”; and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee®, Ultra-Wideband (UWB), Global System for Mobile communication (GSM), second generation (2G), 2.5G, 3G, 3.5G, 4G, 5G, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1.times.RTT), Evolution-Data Optimized (EV-DO), Enhanced Data rates for GSM Evolution (EDGE), and the like. Other embodiments may be used in various other devices, systems and/or networks.

The phrase “hand held device” and/or “wireless device” and/or “mobile device” and/or “portable device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the phrase “wireless device” and/or “mobile device” may optionally include a wireless service and may also refer to wearable computing devices such as smartwatches and eyeglass computing devices (e.g., Google Glass, etc.).

A “hand held device” or HHD is a type of mobile device or wireless device, which can be held in and supported by one's hand during use, such as a smart phone, personal digital assistant (PDA), tablet computing device, laptop computer and the like. It can be appreciated that many devices are not hand held devices and do not constitute an HHD since they are not used as “hand held devices” but as other types of computing devices, such as wearable computing devices. It can be appreciated, however, that other mobile devices such as wearable computing devices can be utilized in place of a hand held device (wearable devices are not “hand held devices” because are not intended to be used in a user's hands but instead worn by the user) or may be utilized with other hand held devices.

The term “communicating” as used herein with respect to wired and wireless communication signals includes transmitting the communication signal and/or receiving the communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit. A wired signal may include a data connection to a router, modem, and wired or optical data network to move the signal for point to point.

Some demonstrative embodiments are described herein with respect to a LTE cellular system. However, other embodiments may be implemented in any other suitable cellular network, e.g., a 3G cellular network, a 4G cellular network, a 5G cellular network, a WiMax cellular network, and the like.

The term “antenna,” as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The terms “cell” or “cellular” as used herein, may include a combination of network resources, for example, downlink and optionally uplink resources. The resources may be controlled and/or allocated, for example, by a cellular node (also referred to as a “base station”), or the like. The linking between a carrier frequency of the downlink resources and a carrier frequency of the uplink resources may be indicated, for example, in system information transmitted on the downlink resources.

Access points, which are often interconnected by cabling, generally play a dominant role in providing radio frequency (RF) coverage in most wireless LAN (WLAN) deployments. Wireless repeaters and mesh network nodes, though, are alternative ways to extend the range of an existing WLAN instead of adding more access points. Some access points have a built-in repeater mode. The wireless communications electronics representing access points, wireless repeaters, and mesh nodes will be referred to herein as communications system nodes, or simply as communications nodes.

In general, a repeater simply regenerates a network signal in order to extend the range of the existing network infrastructure. A WLAN repeater does not physically connect by wire to any part of the network. Instead, it receives radio signals (802.11 frames) from an access point, end user device, or another repeater and retransmits the frames. This makes it possible for a repeater located in between an access point and distant user to act as a relay for frames traveling back and forth between the user and the access point. A mesh node is similar to a repeater excepting that the mesh nodes coordinate the routing of data through a wireless mesh network and that user devices can roam from mesh node to mesh node.

Reference to printing or scanning is not meant to limit the scope of the embodiments. Sensors can take additional forms and formats beyond document scanners, and data rendering devices can also take on different forms and formats beyond document printers. Scanners and printers are utilized throughout the specification as an example of the embodiments without limiting the scope of the features taught herein.

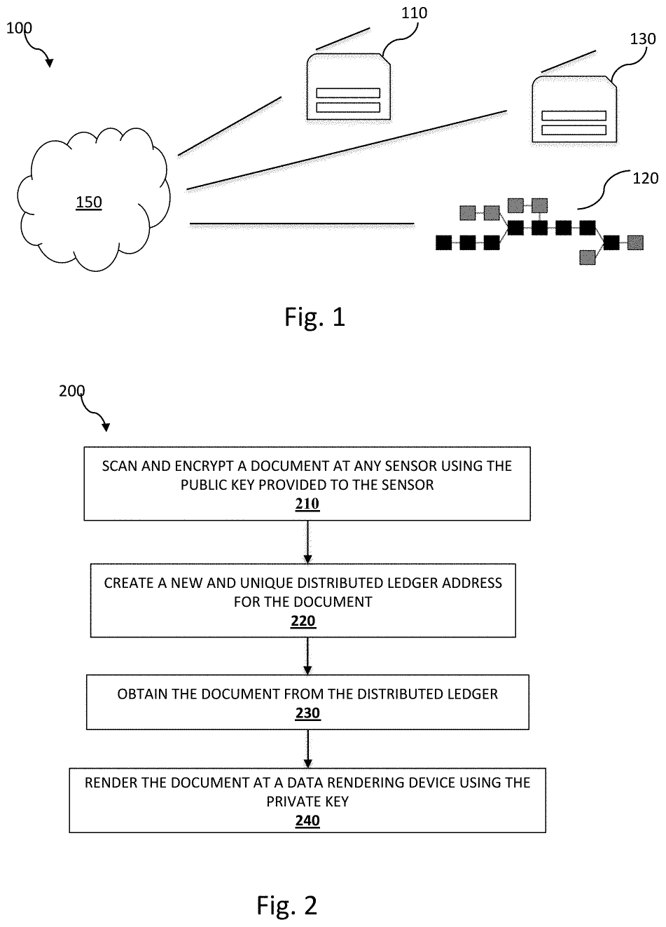

Referring to FIG. 1, a diagram illustrating a system 100 is provided, in accordance with the embodiments. A scanner 110 (type of sensor) 110 can be used to scan a document (acquire data, e.g. data in an organized format that can be printed, viewed, accessed, analyzed.) The document or a document reference can be stored in a blockchain 120 accessible via a data network 150. The data, if not encrypted, can be read by anyone having access to the document whether stored on the blockchain or located using the document reference and can be rendered at a data rendering device 130 (e.g., a printer). The scanner and printer can be blockchain nodes (e.g. ethereum nodes). A document reference is a unique value that can be used to obtain or access a document. A very commonly used data reference is a URL (uniform resource locator) such as http://example.org/document. A data references can also be a key for a key-value data store or relational database, torrent data (e.g. a bit torrent “.torrent” file), a magnet link, a merkle tree key, IPFS content address, etc.

Magnet links identify data (typically files) by its content instead of its location. A cryptographic hash of the data can be used as the identifier. As such, identifiers are essentially digital signatures and can be calculated using DSA, ECDSA, or can be the root key of the data's Merkle tree. Magnet links typically contain many parameters in addition to the digital signature. Those familiar with the operation of peer-to-peer file sharing technologies such as bitTorrent are familiar with magnet links.

Referring to FIG. 2, a flow diagram 200 illustrates a method for managing a document in a public distributed ledger system using asymteric cryptography, in accordance with the embodiments. As shown in Block 210, a document can be scanned and encrypted at any sensor using the public key provided to the sensor. The public key matches a private key, in other words, the private key and the public key are a key pair for asymmetric encryption. As shown in Block 220, a new and unique distributed ledger address can be created for the document. As shown in Block 230, the document can be obtained from the distributed ledger (e.g blockchain). The document can be found on the ledger by using a known ledger address or by examining all the documents accessible via the ledger to find those that can be decrypted using the private key. Then, as shown in Block 240, the document can be rendered at a data rendering device using the private key.

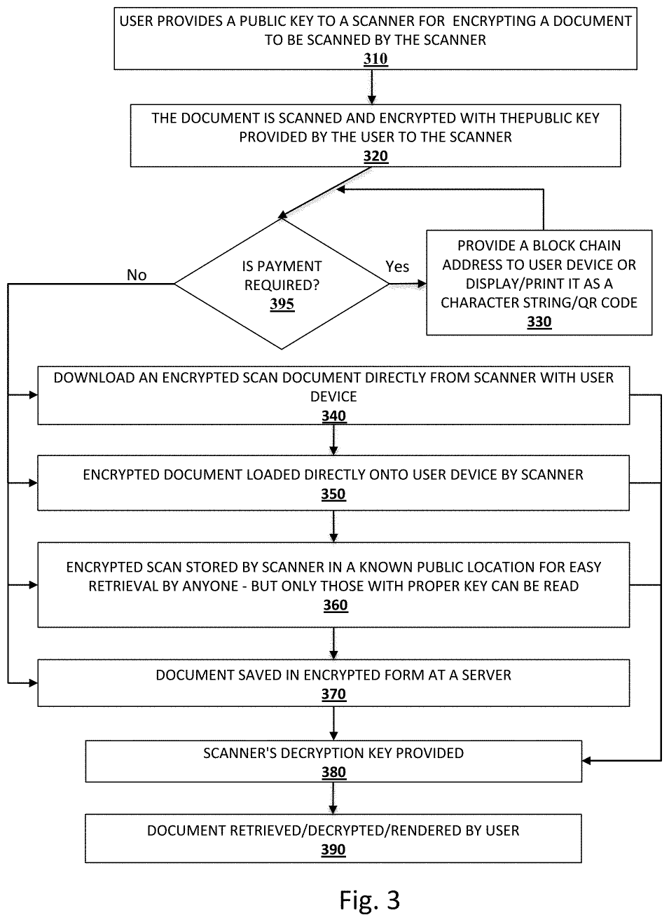

Referring to FIG. 3, a flow diagram of a process 300 in accordance with the embodiments is illustrated. Using public key cryptography, a document can be scanned and encrypted with a public key at any scanner using the public key provided by the user. As shown in Block 310, a user provides a public key to the scanner. Then, as shown in Block 320, the document is scanned and encrypted with the public key at the scanner. There can be a dialog between a user's device and the scanner to communicate information like the public key, preferred file name for a scan, a user's email address, a user's cloud file store (Google drive or something similar). If payment is required 395, the scanner can provide a block chain address to user device or display/print it as a character string/QR code, as shown in Block 330. As shown in the loop through Block 330, the scanner can create a new and unique blockchain address for every scan so it's easy to notice a payment for a specific scan. The dialog can be triggered by scanning a code (e.g. smart phone reads QR code) positioned on the scanner, by an NFC “bump” from a wireless hand held device (e.g., smartphone bumped against NFC enabled scanner), by NFC proximity (e.g. smart phone near NFC tag), by an RFID tag, etc. A user device (e.g., mobile device like a smartphone) can then obtain an encrypted scan document directly from scanner, as shown in Block 340. The scanner can load the encrypted scan directly onto user device (e.g., smartphone, either wirelessly or through a network) as part of a dialog or as directed by a dialog, as shown in Block 350. The scanner can also store encrypted scan in a known public location for easy retrieval by anybody because only those having the private key can decrypt the scan, as shown in Block 360.

The document can be saved in encrypted form at a server after it is scanned (sensed), as shown in Block 370. A scanner, as a form of “sensor”, can incorporate a server function, perhaps serving a web site or a shared folder that can be accessed by user device or a printer. A scanner can also upload a document to a globally accessible server.

As discussed above, the user provides a public key and the encrypted scan can only be read by a person having the decryption key matching the public key. The scanner can also impose a layer of encryption in order to guarantee payment. The scanner can encrypt the encrypted scan using a symmetric or asymmetric key. After being paid, or if some other condition is met, the scanner's decryption key can then be provided 380. The scanner's decryption key can be published for all to see because, once used, the scan is still encrypted with the user's public key. Ideally, the scanner creates new keys for each scan job so that future scan jobs don't use a known scanner decryption key. A scanner can display (or print out), a link or QR a code that a customer can use to access the server or other storage means and to obtain the encrypted scan document. A scanner can attempt to email an encrypted scan to customer (e.g., via a mobile phone app/computer program which can provide email address) and also provide local access upon failure. As shown in Block 390, a user can then retrieve/decrypt/render the document using the private key matching the public key.

Anyone can scan a document at the scanner and provide the public key, even people lacking the private key. As such, one person can scan a document for someone else. The only people that can read the scan are those having the private key and, if required, the scanner's decryption key.

Because the document can only be decoded using the user's private key, it is safe to allow anyone to retrieve the encrypted scan from a server such as when the server/cloud storage is publicly accessible. This can be advantageous because there is no need to manage user accounts or otherwise deal with user permissions. The user and server don't need to coordinate access credentials for accessing the storage. Only intended recipients (those having the private key) can decrypt the scan using the private key. Encrypted scans can be saved, decrypted, stored, archived, rendered (e.g., printed), etc.

Service providers can be involved: Once a document is scanned, the scanner encrypts the scan with the user's public key, producing a once-encrypted scan. For purposes of ensuring payment a service provider can encrypt the scan a second time using the provider's encryption key to produce a twice-encrypted scan. Anyone can retrieve the twice-encrypted scan but only someone with the provider's decryption key and the user's private key can read it. Payment can be by electronic means including crypto currency. The provider's decryption key is provided once payment is made. The provider's decryption key can be provided directly to the payer, provided globally on the server, or can be used to transform the twice-encrypted document (globally available) into the once encrypted document. Anyone with the user's private key can read the once-encrypted document. Any entity, even one lacking the private key, can make the payment. In some use cases, the provider's decryption key is provided only to those making the payment such that many people can pay and receive the provider's decryption key. In other embodiments, the provider's decryption key is available to everyone.

A blockchain implementation can provide a blockchain address for receiving payment. A new blockchain address can be used for every twice-encrypted scan. Payment into the blockchain address can trigger release of the provider's decryption key. The provider's decryption key can be recorded on the blockchain, perhaps at the blockchain address created for the twice-encrypted document, which can incur a transaction cost (bitcoin, ethereum, and similar transactions all have a price). It may cost less to simply publish the provider's decryption key or to decrypt the twice-encrypted document in place.

The provider may create new keys for every scan because otherwise anyone ever receiving the provider's decryption key can obtain a once-encrypted document from a twice-encrypted document. If the provider is using public key cryptography then it can use one key for encrypting and provide the other as the provider's decryption key. If the provider is using symmetric key cryptography then it can use one key for encrypting and provide that same key as the provider's decryption key.

During a dialog, the user can give user's public key, and the scanner can give a block chain address. The scanner can provide a new/unique wallet address for every scan making it easier to detect payment. Either sufficient currency/tokens are received by the address, triggering release of a decryption key, or they aren't.

Regarding data rendering, a user can provide a public key to a printer. The user encrypts a print job with user's private key and sends the encrypted print job to the printer/print queue. The printer uses every public key it knows of to try decrypting the print job. When (if) the printer finds a public key that works then it also knows who sent the document and who to charge for the printing. In some cases, the printer, or a printing facility, will know who to deliver the printed materials to and can implement “override rules” to the print job based on rules associated with the public key. The override rules can be to print on a certain quality machine, to always print in greyscale, to cancel the job if specified total cost/cost per page is exceeded, to apply watermarks, to print simplex or duplex, etc. Advantage—no access dialog with the printer. Just submit encrypted print job and printer figures the rest out. This can work well in controlled or trusted environments.

There may be concern over a potential problem where an abuser can send an encrypted document to get a printout because the abuser can send it thousands of times to drive up user's bill and to consume the printer's paper/toner. The solution to this problem, however, is in the use of blockchain technology. Some crypto-currencies (e.g. those meeting the Ethereum ERC20 standard) have “approve” and “transferFrom” type functionality. A payer records an “approve” transaction, such as “approve(x tokens, recipient's address)”, on the blockchain thereby approving transfer of “x” of the tokens from payer's blockchain address to the recipient's block chain address. In general, the approved amount of tokens, x, can be 0.001, 1, 1.1, 1.5, 1000000.3, or any other number acceptable for transfers on the blockchain. The approval does not transfer any tokens, it approves a future transfer. The recipient can get the tokens by recording a “transferFrom” type transaction, such as “transferFrom(y tokens, payers address)”, on the blockchain. The “transfer from” causes y tokens (if y<=x) to be transferred from payer's block chain address to sender's block chain address. The “approved” amount is reduced to (x−y), which can be zero. In this manner, the user can be charged for printing and, by limiting the approved amount, can limit how much printing is done.

Embodiments requiring payment often need to communicate the cost of performing a job so that the proper amount of cryptocurrency/tokens can be provided. A printer can provide a computer readable rate sheet, algorithm, or service (such as a web API) for determining print cost. When using a rate sheet, the user's device or the user, using its own analysis, predicts the cost. When using an algorithm, the users device can download executable code, execute the code with variables set to values based on the print job's parameters, and thereby obtain a cost. When using a service, the print job can be submitted to the service in a manner similar to submitting it to a printer with the service returning cost data instead of printing the job. The cost data returned by the service can include an amount of currency/tokens to be transferred to a blockchain address to pay for the job, The cost data can also include the blockchain address . The cost data can specify different costs for different priorities such as a high cost for print immediately and a low cost for print whenever. The cost data specify how long the offer is good for.

Returning to the algorithm option, some block chains provide the capability to store algorithms, e.g. Ethereum smart contracts. A user, by means of a block chain transaction, can provide print job parameters to a smart contract. The smart contract can respond by recording cost data for doing the job on the block chain. The cost in tokens can be as simple as (grey scale pages)*(grey scale page price)+(color pages*color page price) with refinements for cost of color duplex page, grey scale duplex page, color simplex, grey scale duplex, and different prices for different page sizes or types of paper. Furthermore, the smart contract can issue print tokens, credit block chain addresses with print tokens, transfer print tokens to and from blockchain addresses, and “burn” print tokens. Burning tokens means reducing the number of tokens at a blockchain address without transferring them elsewhere.

Print tokens can be obtained through minting or transfers. Here, transfer means some other entity transfers tokens to the user, perhaps for money, as an allowance, or for free on request, etc. Minting means tokens have been created by recording their existence on the block chain, sometimes in return for money, for other tokens, work (e.g. proof-of-work mining on bitcoin and ethereum blockchains), for signing blocks, or for no reason at all. Most crypto currencies and tokens have restrictions on how tokens are minted.

In accordance with an embodiment, a user can submit a data rendering request. For purposes of the embodiments, but without intended limitation, a “printer job” will be used to exemplify the process. It can be appreciated that other “jobs” (e.g., display, perform, provide for analysis, etc.) can be the subject of the process disclosed here. The print job is submitted to a service linked to a printer, the service can return a cost and a block chain address. The user can then transfer the cost to the block chain address and then the document can be printed at the will of the user.

In accordance with another embodiment, again using a print job as the example, a user can submit a print job to a service, the service can then return a cost, e.g., x tokens. A printer can have a blockchain addresses that it can communicate to users via NFC, RFID, QR code, web address, etc. The user can also have a blockchain address holding “print” tokens or cryptocurrency. The user's blockchain address and the document (usually encrypted, but not always) can be included as part of the print job. The user can submit the print job to the printer and can also record an “approve” transaction on the blockchain approving transfer of x tokens to one of the printer's blockchain address(es). The printer can use the “transferFrom” method to get the tokens and then print the document(s). The printer can know whose job to print because it can examine the transaction on the blockchain to learn the source of the tokens. When the source of the tokens is a user's blockchain address, that users job can be printed. If the printer provided a unique blockchain address to the user and the user included that blockchain address in the print job then the printer knows which print job to print even if the user has submitted multiple jobs using the same one of the user's blockchain addresses. Using encryption keys to identify a user isn't required when blockchain address can handle payment.

A data rendering device (e.g., printer) can have numerous blockchain addresses and can provide a new one every time someone asks for one. A blockchain address can be specific to the printer. A blockchain address can be specific to a group of printers (data renderers) spread over numerous locations with the printer actually performing the print job also recording the “transferFrom” or dialoging with a service that records the transferFrom. The service can be software running on one or more computers and that can submit transactions for recordation on the blockchain.

In accordance with another embodiment, each print job can have a unique blockchain address. The print job, encrypted with the printer's public key, can include the private key used for signing transactions su8bmitted for the print job's blockchain address. The printer can receive the print job, decrypt it, and check to see if the blockchain address holds enough currency/tokens to pay for the job. If the printing cost can be covered, the printer can deduct the printing cost from the blockchain address and then can print the job. The printer can watch (monitor) for more tokens being stored at the unique blockchain address and, whenever sufficient funds appear (are detected) the printer can deduct the printing cost and print a copy. This can be viewed as a type of “print-on-demand” service when the printer prints a copy of a document whenever sufficient payment appears. Some printers may, in addition, print a cover sheet identifying the intended recipient if that information can be determined from the transaction paying for the document, even if the only available identifier is the source blockchain address of the payment.

Other means of confirmation are possible. A document can store information/rules about how a user (who stands to get billed) wants to confirm transactions. A printer can have its own access controls/rules for confirming printing. These can include trusting submission from specific locations (IP address range, specific device, etc.), requesting an NFC bump from the users device (e.g., mobile wireless device in the form of a smartphone) to the printer (or to a networked NFC bumper—e.g., a bump server can inform a group of device that a device has been “bumped” by another NFC enabled device), proximity between users device and printer (RFID, location services on phone, etc.), clicking a link in a message or email, voice command/agreement through a device near the user. A user can confirm by making payment before printing. This can require encrypted documents to be packaged with information that can determine printing cost (page count, BW/color, etc.).

Rendering can be at specific data (document) rendering devices (e.g. printers). Securely limiting printing to specific printers can be possible through double encryption. A printer's (or print group's) private key can be used to encrypt an envelope containing an already encrypted document (or envelope header, or similar indicia). If the printer knows or is informed of the decryption key, then it can approve printing, request payment, etc.

Another use of the technology is for automatically setting up communications channels. For example, registration of a device onto a WiFi network requires the device to scan for networks, a person to choose a network, and then to enter a passcode. With encryption, the user can provide an encryption key and is done. The key can be a symmetric key or one of an asymmetric key pair. The device can communicate with every other device having the corresponding key. An example using an IOT device such as a light bulb has the bulb arriving with a public key that the user enters into a wireless access point. The public key matches a private key stored within the bulb's radio. At this point, a private channel is established between the access point and bulb. The bulb and access point can then negotiate a different channel such as a WiFi registration, using different or additional keys, etc. Additional channels can be set up by entering the public key into more devices (including access points), or by cooperating devices sharing the public key. Alternatively, the user can connect directly to the bulb and enter the public key for a network having one or more access points. The central point of this device registration method is that devices “discover” one another by being able to communicate over the encrypted channel. The channel itself is visible to all, but only those devices with the correct encryption keys can make use of the channel. Furthermore, devices such as light bulbs can have encryption keys for local encryption, signing keys for publishing signed information, and additional encryption keys for other uses such as publishing encrypted data.

A further aspect of using encryption keys for device registration is that different devices, such as different bulbs, share keys for communication channels, publishing signed information, or publishing encrypted data. Shared local communication keys can ease administration and perhaps simplify hardware implementation or ease hardware requirements. Not sharing keys can increase security and help ensure that every device (also its data, communications channels) is uniquely identified at all times. Devices can move, or roam, between network access points if the devices know the network access points' public keys or if the network access points know the device's public key because a secure channel can be established.

Block channels make device registration even easier because any network or device can have a blockchain address and because any entity having the signing key for an address can register a public key at that address. The network can be associated with an address on a blockchain. The bulb from the previous example can be registered with the network by entering a transaction for that address registering the bulb's public key. Entities on the network (or administering the network) can monitor the blockchain looking for such transactions, notice the new transaction, and add the bulbs public key to the network's locally stored list of public keys. The registration transaction can be performed in a number of ways:
1) The bulb manufacturer or seller can email the bulb's public key to the buyer, can provide it on the packaging, or can otherwise communicate it to the buyer. The buyer can then register the bulb's public key at the network's blockchain address. Here, the buyer never has to access the network hardware or devices, just the blockchain. Note that any entity having the network's signing key can register devices to the network.
2) The seller/manufacturer can provide the public key in association with executable code that automatically generates a blockchain transaction for the buyer to sign with the networks signing key. An example of this is a web page having executable code (javascript, etc.) that requests the network's signing key, the buyer supplies the signing key, and the transaction is automatically submitted to the block chain.
3) The buyer can provide the network's address to the seller/manufacturer who then records a “registrationRequest( )” transaction for the address. The request includes the bulb's public key. The buyer can then enter a “registrationApproved( )” transaction approving the registration and causing the bulb's public key (provided by the manufacturer) to be registered with the network. This can be very simple for the buyer and automated for the seller. This method is similar to the Ethereum ERC20 “Approve( )” and “transferFrom( )” mechanism
4) The bulb can have a blockchain address and the network's public key(s) can be registered with the bulb by any entity having the bulb's signing key. The bulb itself can obtain the network's key(s) whenever the bulb can access blockchain data associated with the bulb's address. If the network's public key is stored on the blockchain in association with the networks blockchain address then the bulb's manufacturer/seller (having the bulb's signing key) can register the network with the bulb. Alternatively, the bulb's signing key can be communicated to the buyer, preferably in encrypted form. The network's public key can be used to encrypt the bulb's signing key. The encrypted signing key can be transmitted using standard methods (email, text, . . . ) or can be stored on the blockchain, perhaps at the bulb's blockchain address or as part of registering the bulb to the network (e.g within the “registrationRequest( )”).

The bulb can be configured to reset itself with a new signing key, public/private key pair, and other keys. In essence, the bulb gets a new identity. The reset process can include using the new keys to register the reset bulb with a specific network address, registering one or more public keys with the reset bulb, and communicating the reset bulb's new signing key such that signed transactions can be submitted to the blockchain in association with the reset bulb's new blockchain address. For example, a “reset” public key can be provided as part of the reset. The bulbs new signing key, encrypted with the “reset” key can be stored on the blockchain at the bulb's new address. Any entity having the private key matching the “reset” key can recover the bulb's new signing key.

Blockchannel techniques also provide for simplified replacement or mirroring of network components. As discussed above, the device registrations are all stored on the blockchain. Other parameters such as signing keys, private keys, public keys, firewall rules, routes, IP addresses, DHCP parameters, VOIP settings, etc. can also be stored in encrypted form on the blockchain and at the network's blockchain address. A new network component having the network's blockchain address and a decryption key (for the stored parameters) can obtain its configuration via the blockchain and automatically configures itself. Alternatively, a configuration already stored can be cloned at a new address, perhaps rewriting certain of the network device specific keys (note the signing key for the new address—must—be rewritten). The new device can configure itself from the data recorded at the new address.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A blockchannel system, comprising:
a sensor adapted to scan and encrypt documents using an encryption key and to store encrypted documents in a blockchain; and
a data rendering device adapted to obtain the encrypted documents from the blockchain, to decrypt the encrypted documents using a decryption key, and to render the documents.

2. The system of claim 1, wherein the sensor is a document scanner.

3. The system of claim 1, wherein the data rending device is a document printer

4. The system of claim 1, wherein the decryption key and the encryption key are an asymmetric key encryption key pair.

5. A method for managing data in a public distributed ledger system using asymmetric cryptography, the method comprising:
sensing and encrypting the data at a sensor using a first key thereby producing encrypted data, wherein an asymmetric cryptographic key pair comprises the first key and a second key;
creating a new and unique distributed ledger address;
submitting a request for a blockchain to store the encrypted data in association with the unique distributed ledger address;
accessing the document via the distributed ledger; and
rendering the data at a data rendering device using the second key.

6. The method of claim 5, wherein the sensor is a document scanner.

7. The method of claim 5, wherein the data rendering device is a document printer.

8. The method of claim 6, wherein a dialog is supported between a user device and the scanner to communicate information comprising the first key.

9. The method of claim 6, wherein the scanner provides the unique distributed ledger address to a user device.

10. The method of claim 6, wherein the scanner displays/prints the unique distributed ledger address as a character string/QR code to a user device.

11. The method of claim 8, wherein the dialog can be triggered via at least one of scanning a code on scanner, bumping an NFC enabled wireless hand held device against the scanner, proximity to the NFC enabled wireless hand held device, sensing an RFID tag.

12. The method of claim 6, where a user device is used to download an encrypted scanned document directly from the scanner.

13. The method of claim 5, wherein a code is provided to at least one user for use in retrieving the encrypted, scanned document.

14. The method of claim 13, wherein the code comprises at least one of the first key or the second key.

15. The method of claim 5, wherein a user can then retrieve and decrypt the document using at least two of the unique distributed ledger address, the first key and the second key.

16. A method for managing documents in a public distributed ledger system using asymmetric cryptography, comprising:
scanning, with a scanner, a document and encrypting the document with a public key provided to the scanner to produce an encrypted document;
creating a new and unique distributed ledger address;
generating a request causing the document to be stored on a blockchain in association with the unique distributed ledger address;
accessing the document from the blockchain; and
rendering the document at a printer using a private key.

17. The method of claim 16, wherein the scanner provides the unique distributed ledger address to a user device.

18. The method of claim 16, wherein a user device is used to download the encrypted document directly from the scanner.

19. The method of claim 5, wherein a code is provided to at least one user for use in retrieving the encrypted document from the blockchain.

20. The method of claim 16, wherein the encrypted document is provided from the scanner to at least one of: a user device configured to download and decrypt the encrypted document directly from scanner, to load the encrypted document directly onto the user device as part of dialog or as directed by dialog, to store the encrypted document in a known public location for easy retrieval by anybody with codes to access and decrypt the encrypted document, to save the encrypted document at a server.
